(19) United States
(12) Patent Application Publication
(10) Pub. No.: US 2026/0221840 A1
(43) Pub. Date: Jul. 30, 2026

(54) Electric Motor and Power Tool Having an Electric Motor

(71) Applicant: Robert Bosch GmbH, Stuttgart (DE)

(72) Inventor: Gyoergy Mucsi, Ditzingen (DE)

(21) Appl. No.: 19/158,236

(22) PCT Filed: Feb. 1, 2024
(86) PCT No.: PCT/EP2024/052519

§ 371 Date: Aug. 20, 2025

(30) Foreign Application Priority Data
Feb. 20, 2023 (DE) 10 2023 201 438.6

(51) Int. Cl. H02K 7/104; H02K 7/14; H02K 11/00; H02K 11/33; H02K 16/04

(52) U.S. Cl. CPC H02K 7/104; H02K 11/0094; H02K 11/33; H02K 16/04; H02K 7/14

(57) ABSTRACT

An electric motor, in particular an axial flow motor, has a rotor and a first and a second stator. The rotor is connected to a motor shaft and is arranged in the axial direction of the motor shaft between the first stator and the second stator. The first stator is designed for operation at a first voltage level, in particular a mains voltage, and the second stator is designed for operation at a second voltage level, in particular a battery voltage.

### PRIOR ART

The present invention relates to an electric motor, in particular to an axial flux motor having a rotor and a first and a second stator, wherein the rotor is connected to a motor shaft and is arranged in the axial direction of the motor shaft between the first stator and the second stator.

From the prior art, an electric motor is known, which is configured as an axial flow motor and comprises a rotor as well as a first and a second stator. The rotor is connected to a motor shaft and arranged in the axial direction of the motor shaft between the first stator and the second stator.

### DISCLOSURE OF THE INVENTION

The invention relates to an electric motor, in particular to an axial flux motor, having a rotor and a first and a second stator, wherein the rotor is connected to a motor shaft and is arranged in the axial direction of the motor shaft between the first stator and the second stator. The first stator is designed for operation at a first voltage level, in particular a mains voltage, and the second stator is designed for operation at a second voltage level, in particular a battery voltage.

The invention thus enables the provision of an electric motor, in which a first and second stator can be used to facilitate a simplified construction for operation at different voltage levels.

Preferably, the first stator is connectable to a voltage network via a mains line, and the second stator is connectable to a battery pack.

Thus, operation via a mains line as well as a battery pack can be facilitated in a simple manner.

Preferably, a first electronics assembly is assigned to the first stator and a second electronics assembly is assigned to the second stator, wherein the first and second electronics assemblies are each configured for motor control.

This enables efficient motor control that is precisely matched to the type of drive chosen by the user—battery operation or mains operation—in the respective operation.

The first stator is preferably arranged at a first axial distance from the rotor, and the second stator is arranged at a second axial distance from the rotor, wherein the first axial distance and the second axial distance are adjustable in a mode-specific manner.

Thus, the first or second stator can be safely and reliably activated for operation at the respective assigned voltage level.

When energizing the first stator in mains operation mode, the first axial distance is preferably set less than the second axial distance.

Thus, efficient mains operation can be facilitated, and the braking effect of the stator designed for battery operation can be at least approximately eliminated by the increased air gap.

When energizing the second stator in a battery operation mode, the second axial distance is preferably set less than the first axial distance.

Thus, efficient battery operation can be facilitated, and the braking effect of the stator designed for mains operation can be at least approximately eliminated by the increased air gap.

According to one embodiment, in the mains operation mode, the first axial distance is in a range of 0.05 mm to 1 mm and the second axial distance is at least 0.06 mm, and in the battery operation mode, the second axial distance is in a range of 0.05 mm to 1 mm and the first axial distance is at least 0.06 mm.

Thus, a suitable first and second axial distance can be precisely and quickly set.

According to one embodiment, the first and second stators are connected to each other and form a stator unit, wherein a sliding device is provided for axially moving the stator unit in a motor housing.

Thus, switching between mains operation and battery operation can be facilitated in a simple manner and an assigned air gap of the operation mode can be realized accordingly.

Preferably, the sliding device is configured to move the first stator axially towards the rotor when energizing the first stator to generate and/or amplify a braking effect is terminated, and to move the second stator axially towards the rotor when energizing the second stator to generate and/or amplify a braking effect is terminated.

Thus, a safe and robust braking effect may be enabled.

Moreover, the present invention provides a power tool, in particular a hand-held power tool, having an electric motor according to the present invention.

The invention thus enables the provision of a power tool having an electric motor in which a simplified design for operation at different voltage levels can be provided by the first and second stator.

Preferably, the first electronics assembly is assigned to mains operation and the second electronics assembly is assigned to battery operation, wherein the first and/or second electronics assembly are integrated in the power tool.

Thus, a safe and reliable arrangement of the first and/or second electronics assembly in the power tool may be enabled.

Preferably, the first electronics assembly is assigned to mains operation and the second electronics assembly is assigned to battery operation, wherein first electronics assembly is integrated into the power line or configured as a unit which can be plugged into the battery pack interface of the power tool.

Thus, an alternative arrangement of the first electronics assembly can be easily and straightforwardly facilitated.

According to one embodiment, the first electronics assembly is assigned to a third electronics assembly, wherein the third electronics assembly is arranged in the power tool, integrated into the first electronics unit, or arranged in the plug-in unit.

Thus, a compact and lightweight power tool can be easily provided, which can be enabled by partitioning the functions of the first electronics assembly.

According to one embodiment, the mains line is detachably arranged on the power tool.

Thus, an arrangement of the mains line can be easily and straightforwardly facilitated.

### BRIEF DESCRIPTION OF THE DRAWINGS

The invention is explained in more detail in the following description with reference to the exemplary embodiments shown in the drawings. The figures show:

FIG. 1 A schematic view of a power tool designed as a hand-held power tool with an electric motor according to the invention,

FIG. 2 A cross-sectional view of the electric motor according to the invention from FIG. 1,

FIG. 3 A schematic view of the electric motor according to the invention from FIG. 1 and FIG. 2, according to another embodiment,

FIG. 4 A schematic view of the electric motor according to the invention from FIG. 3 in a first operating mode,

FIG. 5 A schematic view of the electric motor according to the invention from FIG. 3 and FIG. 4 in another operating mode,

FIG. 6 A schematic view of the power tool designed as a hand-held power tool from FIG. 1, with an alternative arrangement of electronics assemblies assigned to the electric motor,

FIG. 7 A schematic view of the power tool designed as a hand-held power tool from FIG. 1 and FIG. 6, with another arrangement of the electronics assemblies, and

FIG. 8 A schematic view of the power tool designed as a hand-held power tool from FIG. 1, with an alternative arrangement of a power line assigned to the electric motor.

### DESCRIPTION OF THE EXEMPLARY EMBODIMENTS

Elements having the same or a comparable function are provided with the same reference signs in the figures and are described in detail only once.

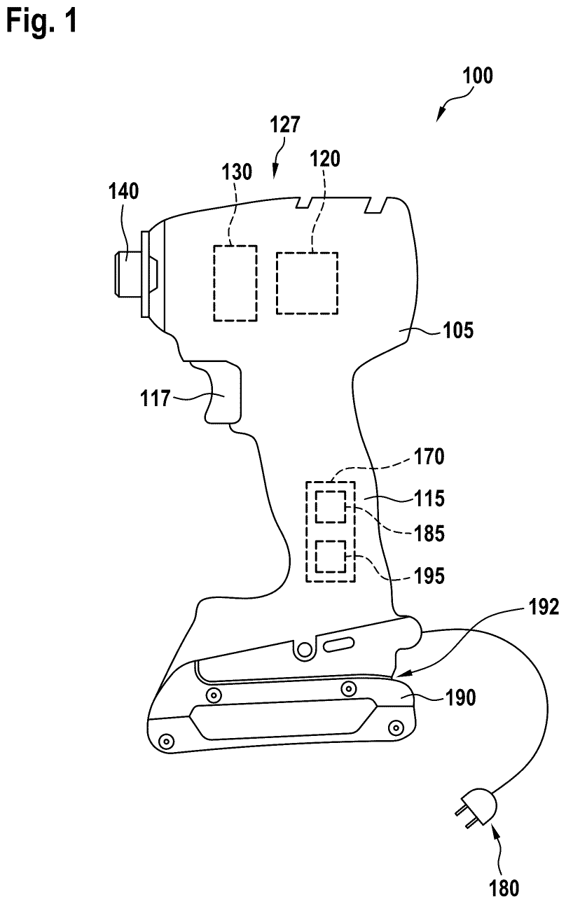

FIG. 1 shows an exemplary power tool 100 designed as a hand-held power tool, which illustratively comprises a housing 105 having a handle 115. Preferably, a tool receptacle 140 for receiving an insert tool, e.g. a screwdriver bit, a drill, etc., is assigned to the power tool 100 designed as a hand-held power tool. It is noted, however, that the present invention is not limited to hand-held power tools such as screwdrivers, drill hammers, impact wrenches, saws, circular saws, but the power tool 100 may also be configured as a garden tool, electric bicycle, etc.

According to one embodiment, the power tool 100 is mechanically and electrically connectable to a battery pack 190 for mains-independent power supply and has a mains cable 180 for mains-dependent power supply. The battery pack 190 is illustratively detachably arranged on a battery pack interface 192 of the power tool 100. The power tool 100 thereby can be operated either independent of the mains or dependent of the mains.

Preferably, a power unit 127 with at least one electric motor 120 is arranged in the housing 105. The electric motor 120 is preferably configured to drive the tool receptacle 140 and thus an insertion tool arranged therein. For example, the electric motor 120 may be switched on and off via a manual switch 117. An optional transmission 130 may be assigned to the drive unit 127.

Preferably, an electronics unit 170 is provided for motor control. Preferably, the electronics unit 170 comprises a first electronics assembly 185 assigned to the mains line 180 and a second electronics unit 195 assigned to the battery pack 190. Preferably, the first and/or second electronics assemblies 185, 195 are integrated into the power tool 100. According to one embodiment, the electronics unit 170 having the first and second electronics assemblies 185, 195 is arranged in the housing 105 of the power tool 100.

For illustration, the electronics unit 170 is arranged in the handle 115. However, the electronics unit 170, or the first and second electronics assemblies 185, 195, may also be arranged at any other location in the power tool 100 and/or in the battery pack 190 or the mains line 180. Alternatively, the first electronics assembly 185 is integrated into the mains line 180 or can be arranged in the battery pack interface 192 of the power tool 100. Furthermore, the mains line 180 can be detachably arranged on the power tool 100.

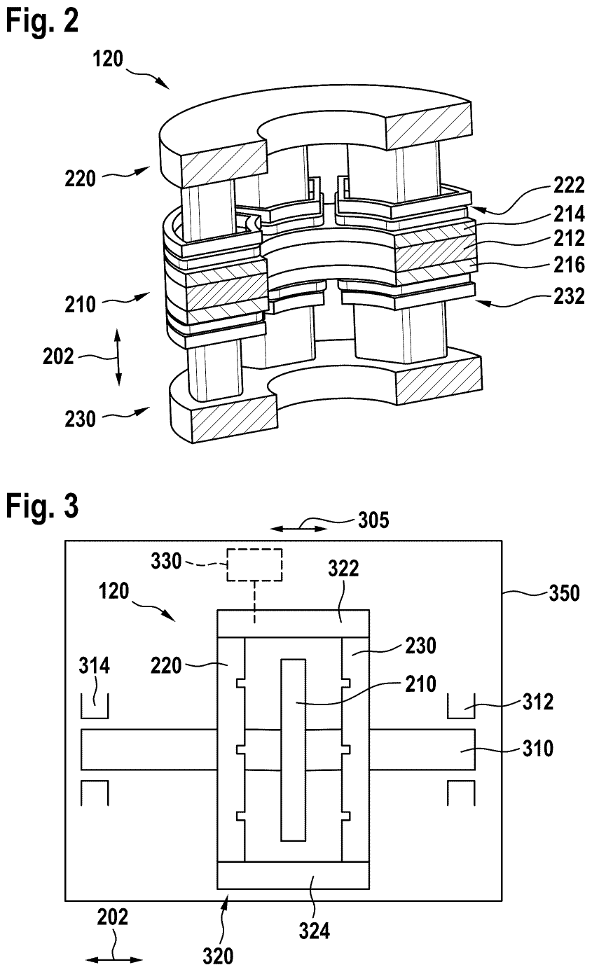

FIG. 2 shows the electric motor 120 of FIG. 1, which is designed as an axial flux motor. The electric motor 120 has a rotor 210 as well as a first and second stator 220, 230. Preferably, the rotor 210 is arranged between the first and second stator 220, 230 in the axial direction 202 of a motor shaft (310 in FIG. 3) assigned to the electric motor 120. For illustration, the first stator 220 is arranged above the rotor 210 and the second stator 230 is arranged below the rotor 210.

Preferably a winding design 222 designed for battery operation is assigned to the first stator 220 and a winding design 232 designed for mains operation is assigned to the second stator 230. Furthermore, a return element 212 is preferably assigned to the rotor 210. Preferably, the rotor 210, in particular the return element 212, has a first magnetic unit 214 arranged facing the first stator 220 and a second magnetic unit 216 arranged facing the second stator 230.

According to one embodiment, the first stator 220 is arranged for operation at a first voltage level, in particular a mains voltage, and the second stator 230 is arranged for operation at a second voltage level, in particular a battery voltage. For this purpose, the first stator 220 can be connected to a voltage network via the mains line 180 in FIG. 1, and the second stator 230 can be connected to the battery pack 190. Preferably, the first electronics assembly 185 for motor control in mains operation is assigned to the first stator 220, and the second electronics assembly 195 for motor control in battery operation is assigned to the second stator 230.

FIG. 3 shows the electric motor 120 of FIG. 1 and FIG. 2 arranged in a motor housing 350, wherein the rotor 210 is connected to a motor shaft 310. The motor shaft 310 is preferably supported by bearing elements 312, 314 in the housing 105 of the power tool 100 shown in FIG. 1. Preferably, the rotor 210 is arranged in the axial direction 202 of the motor shaft 310 between the first stator 220 and the second stator 230.

According to one embodiment, the first and second stators 220, 230 are preferably connected to each other via connecting parts 322, 324 and form a stator unit 320. The rotor 210 is preferably arranged within the stator unit 320. Preferably, a sliding device 330 is provided to axially move the stator unit 320 in the motor housing 350 along the axial direction 202 of the motor shaft 310 or along an arrow 305.

Preferably, the sliding device 330 is configured to move the first stator 220 axially towards the rotor 210 when energizing the first stator 220 to generate and/or amplify a braking effect is terminated, and to move the second stator 230 axially towards the rotor 210 when energizing the second stator 230 to generate and/or amplify a braking effect is terminated. In addition, a further simultaneously applied braking function, e.g., regenerative braking as a generator, can also be enabled.

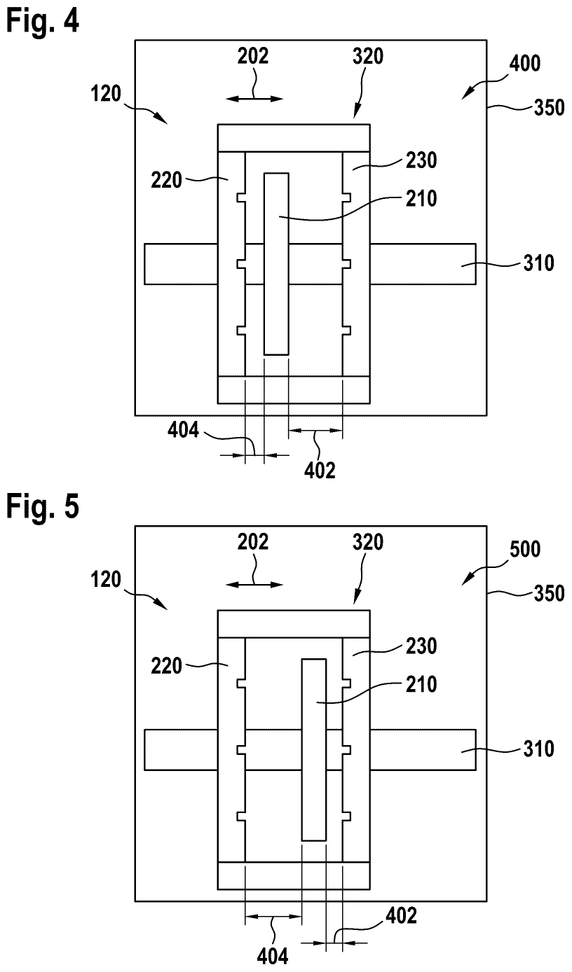

FIG. 4 shows the electric motor 120 from FIG. 1 to FIG. 3 in a mains operation mode 400 in which the first stator 220 is preferably energized. Preferably, the first stator 220 is arranged at a first axial distance 404 to the rotor 210 and the second stator 230 is arranged at a second axial distance 402 to the rotor 210. Here, the first axial distance 404 and the second axial distance 402 are preferably adjustable in a mode-specific manner.

Illustratively, or in the illustrated mains operation mode 400 in which the first stator 220 is energized, the first axial distance 404 is less than the second axial distance 402. In the mains operation mode 400, the first axial distance 404 is preferably in a range of 0.05 mm to 1 mm, and the second axial distance 402 is preferably at least 0.06 mm.

FIG. 5 shows the electric motor 120 from FIG. 1 to FIG. 4 in battery operation mode 500 in which the second stator 230 is energized. In battery operation mode 500, the second axial distance 402 is preferably set to be less than the first axial distance 404. Preferably, in battery operation mode 500, the second axial distance 402 is in a range of 0.05 mm to 1 mm, and the first axial distance 404 is preferably at least 0.06 mm.

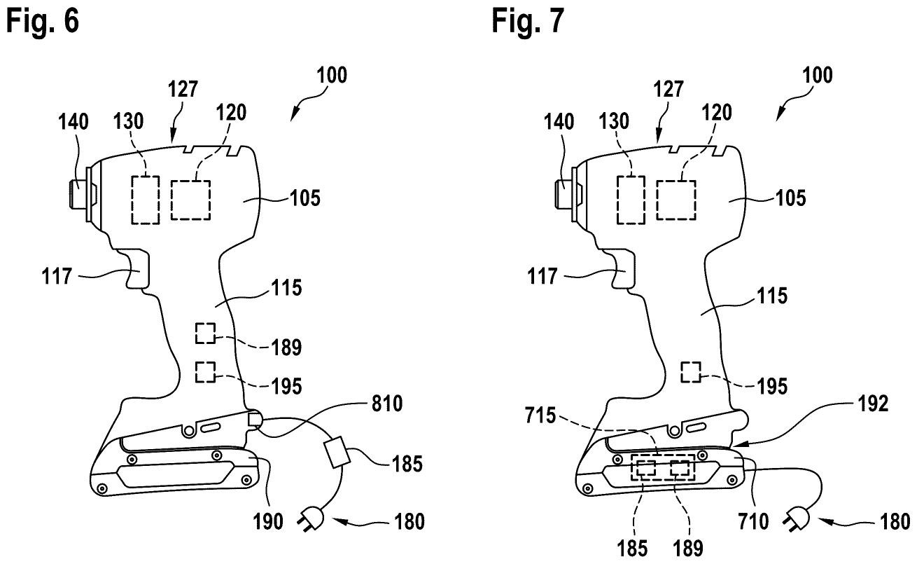

FIG. 6 illustrates the power tool 100 of FIG. 1, configured as an exemplary hand-held power tool, with the first and second electronic assemblies 185, 195 of FIG. 1 for motor control. According to the embodiment shown in FIG. 6, the first electronics assembly 185 is arranged in the mains line 180, and the second electronics assembly 195 is arranged in the power tool 100, illustratively in the handle 115.

Optionally, a third electronics assembly 189 is provided that is configured to replicate some of the functions of the first electronics assembly 185 for mains operation. The third electronics assembly 189 is illustratively arranged in the housing 105 of the power tool 100, in particular in the handle 115.

Preferably, the power line 180 is detachably connected to the power tool 100. For this purpose, the power tool 100, illustratively the housing 105, has a contact point 810.

FIG. 7 shows the power tool 100 of FIG. 1 and FIG. 6, configured as an exemplary hand-held power tool, with an alternative arrangement of the first electronics assembly 185 for motor control. In this case, the first electronics assembly 185 is configured as a unit 710 that can be arranged on the battery pack interface 192 of the power tool 100, in particular a plug-in unit. The battery pack 190 of FIG. 1 is not arranged on the battery pack interface 192. The second electronics assembly 195 is arranged in the power tool 100, as described above. Preferably, the third electronics assembly 189 is arranged in the unit 710. Here, the first and third electronic assemblies 185, 189 form an assembly unit 715.

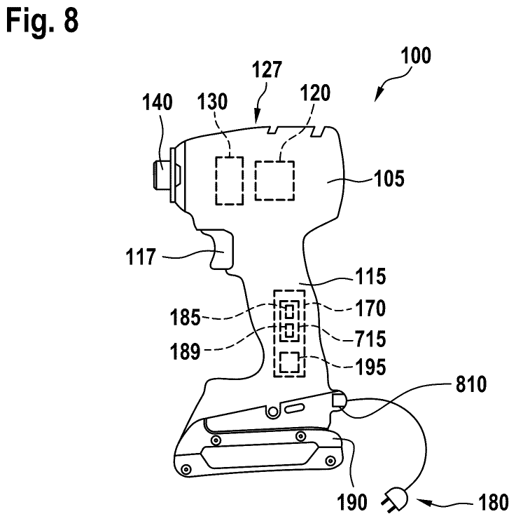

FIG. 8 shows the power tool 100 of FIG. 1, exemplary designed as a hand-held power tool, with the electronics unit 170 having the two electronics assemblies 185, 195 and arranged in the power tool 100. According to one embodiment, the electronics unit 170 is assigned to the assembly unit 715 of FIG. 7, which comprises the first and third electronics assemblies 185, 189. Here, the assembly unit 715 is arranged in the power tool 100, in particular in the handle 115.

1. An electric motor comprising:
a rotor connected to a motor shaft;
a first stator; and
a second stator,
wherein the rotor is arranged in an axial direction of the motor shaft between the first stator and the second stator,
wherein the first stator is configured to operate at a first voltage level and the second stator is configured to operate at a second voltage level.

2. The electric motor according to claim 1, wherein the first stator is configured to connect to a voltage network via a mains line, and the second stator is configured to connect to a battery pack.

3. The electric motor according to claim 1, wherein a first electronics assembly is assigned to the first stator and a second electronics assembly is assigned to the second stator, and the first and second electronics assemblies are each configured for motor control.

4. The electric motor according to claim 1, wherein:
the first stator is arranged at a first axial distance to the rotor,
the second stator is arranged at a second axial distance to the rotor, and
the first axial distance and the second axial distance are adjustable in a mode-specific manner.

5. The electric motor according to claim 4, wherein the electric motor has a mains operation mode in which the first stator is energized and the first axial distance is set less than the second axial distance.

6. The electric motor according to claim 4, wherein the electric motor has a battery operation mode in which the second stator is energized and the second axial distance is set less than the first axial distance.

7. The electric motor according to claim 5, wherein:
the electric motor has a battery operation mode in which the second stator is energized and the second axial distance is set less than the first axial distance,
in the mains operation mode the first axial distance is in a range from 0.05 mm to 1 mm and the second axial distance is at least 0.06 mm, and
in the battery operation mode the second axial distance is in a range from 0.05 mm to 1 mm and the first axial distance is at least 0.06 mm.

8. The electric motor according to claim 1, wherein:
the first and second stators are connected to each other and form a stator unit, and
a sliding device is provided for axially moving the stator unit in a motor housing.

9. The electric motor according to claim 8, wherein the sliding device is configured to move the first stator axially towards the rotor when energization of the first stator is terminated to generate and/or amplify a first braking effect, and to move the second stator axially towards the rotor when energization of the second stator is terminated to generate and/or amplify a second braking effect.

10. A power tool comprising:
an electric motor according to claim 1.

11. The power tool according to claim 10 further comprising:
a first electronics assembly assigned to mains operation; and
a second electronics assembly assigned to battery operation,
wherein at least one of the first and second electronics assemblies is integrated into the power tool.

12. The power tool according to claim 10 further comprising:
a first electronics assembly assigned to mains operation; and
a second electronics assembly assigned to battery operation,
wherein the first electronics assembly is integrated into a mains line or is configured as a plug-in unit which is configured to be plugged into a battery pack interface of the power tool.

13. The power tool according to claim 12 wherein:
the first electronics assembly is assigned to a third electronics assembly, and
the third electronics assembly is arranged in the power tool, is integrated in the first electronics unit, or is arranged in the plug-in unit.

14. The power tool according to claim 12, wherein the mains line is detachably arranged on the power tool.

15. The electric motor according to claim 1, wherein the electric motor is an axial flow motor.

16. The electric motor according to claim 1, wherein the first voltage level is a mains voltage, and the second voltage level is a battery voltage.

17. The power tool according to claim 10, wherein the power tool is a hand-held power tool.
